(19) United States
(12) Patent Application Publication
(10) Pub. No.: US 2025/0172830 A1
(43) Pub. Date: May 29, 2025

(54) METHOD FOR FABRICATING A KERR EFFECT ELECTRO-OPTICAL MODULATOR

(71) Applicant: COMMISSARIAT A L'ENERGIE ATOMIQUE ET AUX ENERGIES ALTERNATIVES, Paris (FR)

(72) Inventors: Imene REGHIOUA, Grenoble Cedex 09 (FR); Leopold VIROT, Grenoble Cedex 09 (FR); Jonathan PELTIER, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/956,229

(22) Filed: Nov. 22, 2024

(30) Foreign Application Priority Data
Nov. 24, 2023 (FR) 2313006

(51) Int. Cl. G02F 1/025; G02F 1/015

(52) U.S. Cl. CPC G02F 1/025; G02F 1/0152; G02F 1/0154

(57) ABSTRACT

A method is provided for manufacturing a Kerr effect electro-optical modulator that includes using a substrate, forming a waveguide on the substrate so as to guide a propagation of an electromagnetic wave, irradiating the interface with an ionizing radiation so as to trap at the interface (I) free carriers originating from the p-n junction or from the p-i-n structure, and polarizing the p-n junction or the p-i-n structure so as to apply an electrical field within the core. The waveguide includes: a core, comprising a p-n junction or a p-i-n structure; and an optical sheath, enclosing the core. The core and the optical sheath have an interface.

### TECHNICAL FIELD

The invention relates to the technical field of Kerr effect electro-optical modulators.

The invention is, notably, applicable to transmitters for optical communications, due to their high bandwidth and low energy consumption.

### PRIOR ART

A method for fabricating a Kerr effect electro-optical modulator known from the prior art comprises the steps of:
A) using a substrate;
B) forming a waveguide on the substrate so as to guide a propagation of an electromagnetic wave, the waveguide comprising:
   a core, comprising a p-n junction or a p-i-n structure;
   an optical sheath enclosing the core;
C) polarizing the p-n junction or the p-i-n structure so as to apply an electrical field within the core.

Such a prior art method is not entirely satisfactory, since the modulation of the phase of the electromagnetic wave propagated within the core is not solely achieved by the modulation of the electrical field applied within the core, called the Kerr effect. In fact, the variation of the density of free carriers, originating from the p-n junction or the p-i-n structure, will also contribute to the modulation of the phase (and amplitude) of the electromagnetic wave propagated within the core. This phenomenon is called the plasma dispersion effect (PDE). Such a prior art method therefore gives rise to a competition between the Kerr effect and the plasma dispersion effect.

Furthermore, the variation of the density of free carriers, originating from the p-n junction or the p-i-n structure, will also cause a change in the optical absorption of the electromagnetic wave propagated within the core, thereby degrading the performance of the electro-optical modulator. This phenomenon is called the “chirp” effect, and limits, notably, the maximum modulation frequency of the electro-optical modulator.

### SUMMARY OF THE INVENTION

The invention is intended to overcome, wholly or partially, the aforesaid drawbacks. To this end, the invention relates to a method for fabricating a Kerr effect electro-optical modulator comprising the steps of:
a) using a substrate;
b) forming a waveguide on the substrate so as to guide a propagation of an electromagnetic wave, the waveguide comprising:
   a core, comprising a p-n junction or a p-i-n structure;
   an optical sheath enclosing the core;
the core and the optical sheath having an interface;
c) irradiating the interface with an ionizing radiation so as to trap at the interface free carriers originating from the p-n junction or from the p-i-n structure;
d) polarizing the p-n junction or the p-i-n structure so as to apply an electrical field within the core.

Thus, such a method according to the invention makes it possible, thanks to step c), to limit or even eliminate the harmful effects of the free carriers in terms of the chirp effect and the plasma dispersion effect. In fact, some or all of the free carriers are trapped at the interface between the core and the optical sheath of the waveguide, owing to the ionizing radiation applied in step c). The ionizing radiation enables defects to be created at the interface between the core and the optical sheath, thus forming free carrier trapping sites

In other words, such a method according to the invention allows the pure phase modulation (that is to say, without amplitude modulation or with limited amplitude modulation compared with the prior art) of the electromagnetic wave propagated within the core of the waveguide, and allows a higher maximum modulation frequency of the electro-optical modulator compared with the prior art.

The method according to the invention may have one or more of the following features.

According to one feature of the invention:
step c) causes a concentration of the free carriers trapped at the interface;
step c) is followed by a thermal annealing step executed according to a suitable thermal budget in order to reduce the concentration of free carriers trapped at the interface.

Thus, one advantage gained is that of being able to reduce the concentration of the free carriers trapped at the interface between the core and the optical sheath of the waveguide, in order to reduce the optical losses of the electro-optical modulator. Such thermal annealing makes it possible to neutralize the defects produced by the ionizing radiation applied in step c).

According to one feature of the invention, step c) is executed using a radiation dose greater than or equal to a threshold above which the free carriers originating from the p-n junction or from the p-i-n structure no longer travel in an area of the core where a propagation mode of the electromagnetic wave is guided.

Thus, one advantage gained is that of eliminating the plasma dispersion effect and the chirp effect for the guided propagation mode.

According to one feature of the invention, step c) is executed with X-rays.

Thus, one advantage gained is the ease of obtaining such ionizing radiation. The energy of the X-rays is sufficient to obtain an ionizing radiation that passes through an electro-optical modulator chip, for example one which is integrated on silicon.

According to one feature of the invention, step b) is executed with a core made of a material chosen from among silicon, a silicon-rich amorphous silicon carbide and a silicon-rich silicon nitride.

Thus, one advantage gained by such materials is that a high Kerr effect is obtained because of their high second-order nonlinear refractive index. Another advantage is their high breakdown voltage.

According to one feature of the invention, step a) is executed with a semiconductor-on-insulator substrate comprising, in succession:
a wafer;
a dielectric layer, forming part of the optical sheath of the waveguide formed in step b);
a layer made of a semiconductor material from which the core of the waveguide is formed in step b).

Thus, one advantage gained by such a substrate is that the fabrication of the waveguide is facilitated because part of the optical sheath is already present with the dielectric layer. If the semiconductor material is silicon, one advantage gained is that use is made of integrated photonics on silicon, that is to say the integration of the photonic functions with electronic circuits on the scale of the silicon wafer.

According to one feature of the invention, step b) is executed with an optical sheath made of silicon dioxide, SiO₂.

Thus the properties of this material are useful in terms of refractive index (which must be less than that of the core), CMOS (Complementary Metal Oxide Semiconductor) compatibility, and electrical isolation.

According to one feature of the invention, step b) is executed in such a way that the resulting waveguide is ridged, the core comprising:
a planar, lower area comprising the p-n junction or the p-i-n structure;
an upper area, forming a ridge or two ridges, which surmounts the lower area, and in which a propagation mode of the electromagnetic wave is guided.

Thus, one advantage gained by such a waveguide architecture is that it facilitates the removal of the free carriers of the lower area toward the trapping sites created at the interface between the core and the optical sheath by the ionizing radiation, in order to obtain an upper area with the fewest possible free carriers. In particular, a double-ridge architecture makes it possible to increase the proportion of the optical mode lying in the intrinsic area, in order to limit the doping losses.

According to one feature of the invention, the radiation dose is greater than or equal to the threshold above which the free carriers originating from the p-n junction or the p-i-n structure no longer travel in the upper area of the core where the propagation mode of the electromagnetic wave is guided.

Thus, one advantage gained is that of eliminating the contribution of the plasma dispersion effect and the chirp effect for the guided propagation mode in the ridged upper area of the waveguide. The free carriers are then no longer able to travel from the lower area toward the upper area of the core where the propagation mode of the electromagnetic wave is guided. Everything takes place as though the charges trapped at the interface between the core and the optical sheath created a “pinch-off,” blocking any channel allowing the free carriers to travel from the lower area toward the upper area of the core where the propagation mode of the electromagnetic wave is guided.

According to one feature of the invention, step b) is executed in such a way that the resulting waveguide comprises an encapsulation layer enclosing the optical sheath.

### Definitions

“Electro-optical modulator” is taken to mean a device comprising a medium adapted to modulate the phase of an electromagnetic wave propagated in the medium, when an external electrical field is applied to this medium.

“Kerr effect” is taken to mean the electro-optical Kerr effect, also called the “DC Kerr effect,” which differs from the optical Kerr effect (or “AC Kerr effect”).

“Substrate” is taken to mean a self-supporting physical support made of a base material from which a waveguide may be formed. A substrate may be a “wafer” which usually takes the form of a disk formed by cutting from a bar of crystalline material.

“p-n junction” is taken to mean a junction between a p-type doped area and an n-type doped area. The p-type doped area comprises p-type dopants, that is to say species (e.g. impurities) which, when introduced into the matrix of the material of the waveguide core, accept an electron from the conduction band. The n-type doped area comprises n-type dopants, that is to say species (e.g. impurities) which, when introduced into the matrix of the material of the waveguide core, donate an electron to the conduction band.

“p-i-n type structure” is taken to mean a junction between a p-type doped area and an intrinsic area, and a junction between the intrinsic area and an n-type doped area. The p-type doped area comprises p-type dopants, that is to say species (e.g. impurities) which, when introduced into the matrix of the material of the waveguide core, accept an electron from the conduction band. The n-type doped area comprises n-type dopants, that is to say species (e.g. impurities) which, when introduced into the matrix of the material of the waveguide core, donate an electron to the conduction band. The intrinsic area contains no dopants.

“Free carriers” is taken to mean the carriers of electrical charges (electrons and holes) that are free to travel within the waveguide core.

“Polarize” is taken to mean the application of an electrical potential difference between the p-type doped area and the n-type doped area of the p-n junction or of the p-i-n structure.

“Electrical field” is taken to mean an electrical field having a sufficiently high intensity for a third-order nonlinear susceptibility in the waveguide core to create a Kerr effect. The electrical field intensity must remain below the maximum value of the electrical field that the electro-optical modulator can withstand before a breakdown of any of its constituent materials.

“Ionizing radiation” is taken to mean a radiation having sufficient energy to strip away at least one electron from the atoms through which the ionizing radiation passes. In this case, the ionizing radiation is adapted to strip away at least one electron from the atoms of the material from which the optical sheath is made.

“Thermal annealing” is taken to mean a heat treatment comprising:
(i) a phase of gradual temperature rise (heating ramp) until what is called the annealing temperature is reached;
(ii) a phase (plateau) of holding at the annealing temperature for a time called the annealing time;
(iii) a cooling phase.

“Thermal budget” is taken to mean a contribution of thermal energy, determined by the choice of a value of the annealing temperature and the choice of a value of the annealing time.

“X-rays” is taken to mean electromagnetic radiation whose wavelength is between 0.001 nm and 10 nm.

### BRIEF DESCRIPTION OF THE DRAWINGS

Other features and advantages will be apparent from the detailed description of different embodiments of the invention, the description being accompanied with examples and references to the attached drawings.

FIG. 1 is a schematic sectional view of an example of an electro-optical modulator fabricated by a method according to the invention, the core of the waveguide comprising a p-n junction.

FIG. 2 is a schematic sectional view of an example of an electro-optical modulator fabricated by a method according to the invention, the core of the waveguide comprising a p-i-n structure.

FIG. 3 is a schematic partial sectional view on an enlarged scale of a waveguide (ridged structure) of an electro-optical modulator fabricated by a method according to the invention.

FIG. 4 is a schematic partial sectional view on an enlarged scale of a waveguide (double-ridge structure) of an electro-optical modulator fabricated by a method according to the invention.

FIG. 5 is a schematic sectional view of a semiconductor-on-insulator substrate that can be used for step a) of a method according to the invention.

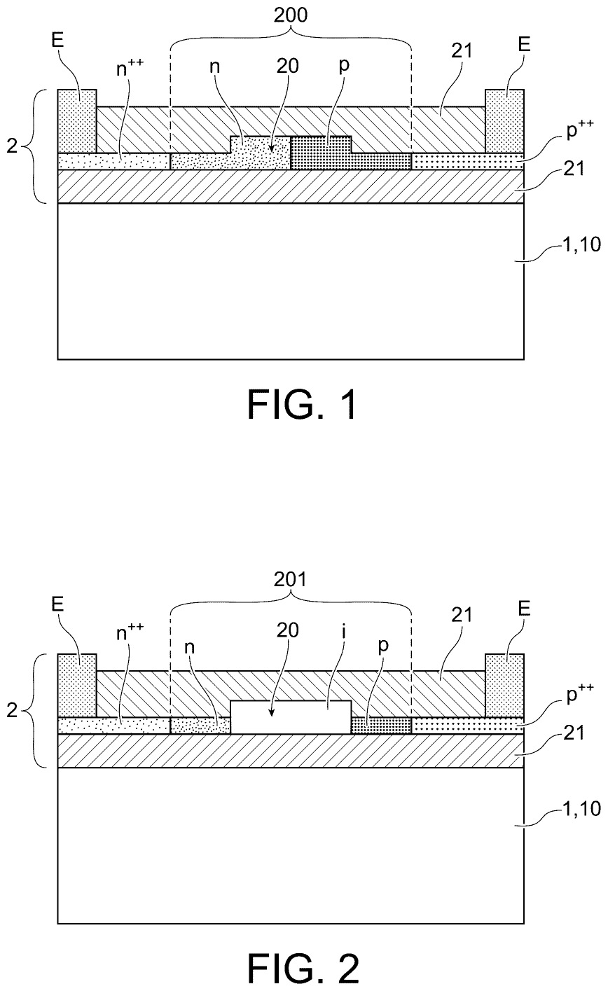

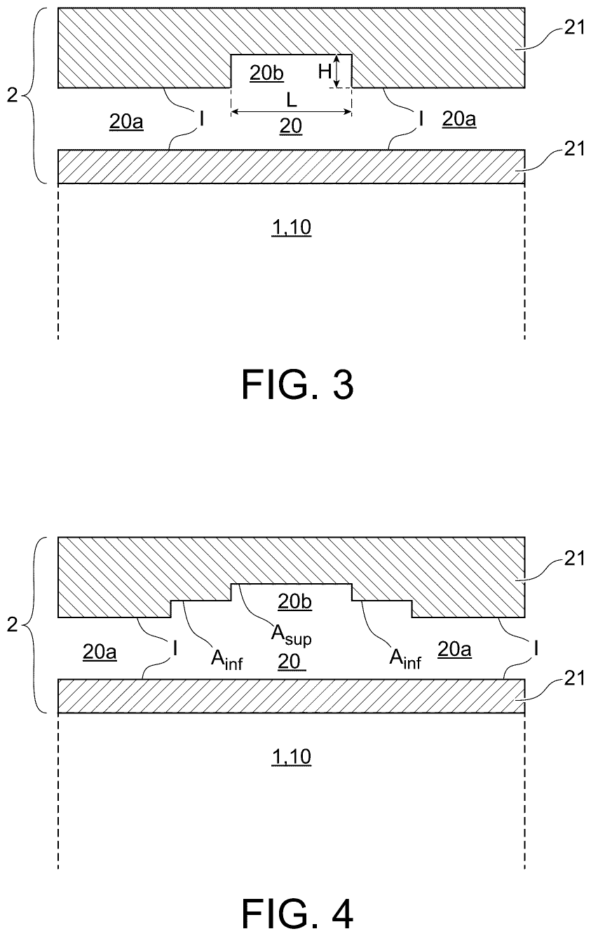

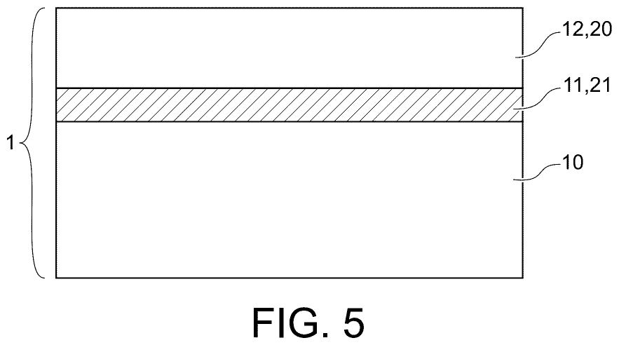

It should be noted that the drawings described above are schematic, and are not necessarily to scale, in the interests of readability and with the aim of making them simpler to understand. The sections are taken along the normal to the surface of the substrate.

### DETAILED DESCRIPTION OF THE EMBODIMENTS

For the sake of simplicity, elements that are identical or have the same function are given the same references for the various embodiments.

The invention relates to a method for fabricating a Kerr effect electro-optical modulator, comprising the steps of:
a) using a substrate 1;
b) forming a waveguide 2 on the substrate 1 so as to guide a propagation of an electromagnetic wave, the waveguide 2 comprising:
   a core 20, comprising a p-n junction 200 or a p-i-n structure 201;
   an optical sheath 21 enclosing the core 20;
the core 20 and the optical sheath 21 having an interface I;
c) irradiating the interface I with an ionizing radiation so as to trap at the interface I free carriers originating from the p-n junction 200 or from the p-i-n structure 201;
d) polarizing the p-n junction 200 or the p-i-n structure 201 so as to apply an electrical field within the core 20.

### Step a)

Step a) consists in using a substrate 1 from which the waveguide 2 will be formed.

Step a) is advantageously executed with a semiconductor-on-insulator substrate 1, comprising, in succession:
a wafer 10;
a dielectric layer 11, forming part of the optical sheath 21 of the waveguide 2 formed in step b);
a layer 12 (called the useful layer) made of a semiconductor material, from which the core 20 of the waveguide 2 is formed in step b).

The wafer 10 may be made of silicon. The dielectric layer 11 forms the lower part of the optical sheath 21 of the waveguide 2 formed in step b). The dielectric layer 11 is therefore advantageously made of the same material as the upper part of the optical sheath 21 of the waveguide formed in step b). The useful layer 12 is advantageously made of a semiconductor material which is the material of the core 20 of the waveguide 2 formed in step b).

By way of non-limiting example, a semiconductor-on-insulator substrate 1 may be formed by the Smart-Cut™ technology which is known to those skilled in the art.

### Step b)

Step b) consists in forming a waveguide 2 on the substrate 1. The waveguide 2 is arranged to guide an electromagnetic wave within itself.

The waveguide 2 comprises a core 20. Step b) is advantageously executed with a core 20 made of a material chosen from among silicon, a silicon-rich amorphous silicon carbide and a silicon-rich silicon nitride.

In particular, the silicon-rich amorphous silicon carbide has a second-order nonlinear refractive index of 2.5 10⁻¹⁷ m²/W, about four times greater than that of silicon. Moreover, the silicon-rich amorphous silicon carbide has a band gap of 2.1 eV, higher than silicon, thus suppressing two-photon absorption at telecommunications wavelengths. Silicon-rich amorphous silicon carbide has a refractive index of 2.6, enabling the confinement of the electromagnetic wave to be reduced by comparison with silicon. Finally, silicon-rich amorphous silicon carbide has a higher breakdown voltage than that of silicon.

Silicon-rich silicon nitride has a second-order nonlinear refractive index of 2 10⁻¹⁷ m²/W, a refractive index of 3, and a higher breakdown voltage than that of silicon.

The core 20 of the waveguide 2 is advantageously formed from the useful layer 12 of the substrate 1.

The core 20 comprises a p-n junction 200. According to one alternative, the core 20 comprises a p-i-n structure 201. The p-n junction 200 and the p-i-n structure 201 can be formed by doping techniques known to those skilled in the art, for example by implantation or by diffusion. By way of non-limiting example, p-type doping can be carried out by introducing boron. N-type doping can be carried out by introducing phosphorus. The p-type dopants of the p-n junction 200 or of the p-i-n structure 201 may have a concentration of the order of 10¹⁷ cm⁻³. The n-type dopants of the p-n junction 200 or of the p-i-n structure 201 may have a concentration of the order of 10¹⁸ cm⁻³. The waveguide 2 advantageously comprises a highly doped p-type area p⁺⁺, arranged to connect the p-type doped area of the p-n junction 200 or of the p-i-n structure 201 to a metallic contact area E. The concentration of the p-type dopants of the area p⁺⁺ may be as much as 10²⁰ cm⁻³. The waveguide 2 advantageously comprises a highly doped n-type area n⁺⁺, arranged to connect the n-type doped area of the p-n junction 200 or of the p-i-n structure 201 to a metallic contact area E. The concentration of the n-type dopants of the area n⁺⁺ may be as much as 10²⁰ cm⁻³.

The waveguide 2 comprises an optical sheath 21, extending around the core 20 along an interface I. The optical sheath 21 has a refractive index strictly below that of the core 20. The upper part of the optical sheath 21 may be formed by a deposition technique known to those skilled in the art. The lower part of the optical sheath 21 may be the dielectric layer 11 of the substrate 1. Step b) is advantageously executed with an optical sheath 21 made of silicon dioxide, SiO₂.

According to one embodiment, step b) is executed in such a way that the resulting waveguide 2 is ridged, the core 20 comprising:
a planar, lower area 20a comprising the p-n junction 200 or the p-i-n structure 201;
an upper area 20b, forming a ridge, which surmounts the lower area 20a, and in which a propagation mode of the electromagnetic wave is guided.

Other architectures of the waveguide 2 would be feasible, for example a rectangular waveguide 2 (or “strip”). However, one advantage gained by a ridged architecture is that it facilitates the removal of the free carriers from the lower area 20a toward the trapping sites created at the interface I between the core 20 and the optical sheath 21 by the ionizing radiation, in order to obtain an upper area 20b with the fewest possible free carriers. By way of non-limiting example, the upper area 20b of the ridged waveguide 2 may have a width L of 400 nm, and a height H of 220 nm.

According to one embodiment, step b) is executed in such a way that the resulting waveguide 2 is ridged, the core 20 comprising:
a planar, lower area 20a comprising the p-n junction 200 or the p-i-n structure 201;
an upper area 20b, forming two ridges A_{inf}, Aₛᵤₚ, which surmounts the lower area 20a, and in which a propagation mode of the electromagnetic wave is guided.

The upper ridge Aₛᵤₚ is arranged to confine the optical mode laterally. The lower ridge A_{inf} extends under the upper ridge Aₛᵤₚ, on either side of the upper ridge Aₛᵤₚ. The lower ridge Aᵢₙₜ delimits two underlying areas, a first underlying area comprising n-type dopants and a second underlying area comprising p-type dopants. Such a double-ridge architecture enables the electrical field to be applied as closely as possible to the optical mode in step d).

Step b) is advantageously executed in such a way that the resulting waveguide 2 comprises an encapsulation layer (not shown) enclosing the optical sheath 21. In other words, the encapsulation layer extends around the optical sheath 21. The encapsulation layer, which may be made from a polymer, may be deposited on the upper part of the optical sheath 21 by a deposition technique known to those skilled in the art.

### Step c)

Step c) consists in applying an ionizing radiation to the interface I between the core 20 and the optical sheath 21 of the waveguide 2. For practical reasons, the irradiation of step c) is advantageously global, in the sense that the whole of the waveguide 2 formed in step b) is irradiated. The ionizing radiation must at least reach the interface I between the core 20 and the optical sheath 21. More precisely, the ionizing radiation must at least reach the interface I between the core 20 and the upper part of the optical sheath 21. In practice, the irradiation of step c) is global, and the whole of the interface I between the core 20 and the optical sheath 21 is reached by the ionizing radiation.

Step c) is executed in such a way that free carriers originating from the p-n junction 200 or originating from the p-i-n structure 201 are trapped at the interface I between the core 20 and the optical sheath 21 of the waveguide 2. By way of non-limiting example, for a dose of ionizing radiation of the order of 10⁶ Gy (Gray), the concentration of the free carriers trapped at the interface I is of the order of 10²⁰ cm⁻³.

Step c) is advantageously executed with X-rays. The energy of the X-rays is sufficient to obtain an ionizing radiation that passes through an electro-optical modulator chip, for example one which is integrated on silicon. Gamma radiation may also be considered for use as an ionizing radiation for some applications.

Step c) is advantageously executed using a radiation dose greater than or equal to a threshold above which the free carriers (originating from the p-n junction 200 or from the p-i-n structure 201) no longer travel in an area of the core 20 where a propagation mode of the electromagnetic wave is guided. In the case of a ridged waveguide 2, the radiation dose is greater than or equal to the threshold above which the free carriers (originating from the p-n junction 200 or from the p-i-n structure 201) no longer travel in the upper area 20b of the core 20 where the propagation mode of the electromagnetic wave is guided. By way of non-limiting example, in the case of X-rays with a silicon core 20 and a silicon dioxide optical sheath 21, the threshold is of the order of 10⁶ Gy.

Step c) causes a concentration of the free carriers trapped at the interface I between the core 20 and the optical sheath 21 of the waveguide 2. Step c) is advantageously followed by a thermal annealing step, executed according to a suitable thermal budget in order to reduce the concentration of the free carriers trapped at the interface I between the core 20 and the optical sheath 21 of the waveguide 2. The thermal annealing step is executed before step d). By way of non-limiting example, in the case of X-rays with a silicon core 20 and a silicon dioxide optical sheath 21, the annealing temperature may be of the order of 200° C.

### Step d)

Step d) consists in polarizing the p-n junction 200 or the p-i-n structure 201. Step d) is executed so as to apply an electrical field within the core 20 of the waveguide 2.

The intensity of the electrical field must be sufficiently high for a third-order nonlinear susceptibility in the core 20 of the waveguide 2 to create a Kerr effect. The electrical field intensity must remain below the maximum value of the electrical field that the electro-optical modulator can withstand before a breakdown of any of its constituent materials. For example, for a core 20 made of silicon, the breakdown field is of the order of 2.5 10⁵ V/cm. The voltage applied between the metallic contact areas E may then be of the order of ten to several tens of volts.

The invention is not limited to the embodiments described above. Those skilled in the art will be capable of considering their technically useful combinations and substituting equivalents for them.

1. A method for fabricating a Kerr effect electro-optical modulator, comprising the steps of:
a) using a substrate;
b) forming a waveguide on the substrate so as to guide a propagation of an electromagnetic wave, the waveguide comprising:
a core, comprising a p-n junction or a p-i-n structure;
an optical sheath enclosing the core;
the core and the optical sheath having an interface;
c) irradiating the interface with an ionizing radiation so as to trap at the interface free carriers originating from the p-n junction or from the p-i-n structure;
d) polarizing the p-n junction or the p-i-n structure so as to apply an electrical field within the core.

2. The method as claimed in claim 1, wherein:
step c) causes a concentration of the free carriers trapped at the interface;
step c) is followed by a thermal annealing step executed according to a suitable thermal budget in order to reduce the concentration of free carriers trapped at the interface.

3. The method as claimed in claim 1, wherein step c) is executed using a radiation dose greater than or equal to a threshold above which the free carriers originating from the p-n junction or from the p-i-n structure no longer travel in an area of the core where a propagation mode of the electromagnetic wave is guided.

4. The method as claimed in claim 1, wherein step c) is executed with X-rays.

5. The method as claimed in claim 1, wherein step b) is executed with a core made of a material chosen from among silicon, a silicon-rich amorphous silicon carbide and a silicon-rich silicon nitride.

6. The method as claimed in claim 1, wherein step a) is executed with a semiconductor-on-insulator substrate comprising, in succession:
a wafer;
a dielectric layer, forming part of the optical sheath of the waveguide formed in step b);
a layer made of a semiconductor material, from which the core of the waveguide is formed in step b).

7. The method as claimed in claim 1, wherein step b) is executed with an optical sheath made of silicon dioxide, SiO₂.

8. The method as claimed in claim 1, wherein step b) is executed in such a way that the resulting waveguide is ridged, the core comprising:
a planar, lower area comprising the p-n junction or the p-i-n structure;
an upper area, forming a ridge or two ridges A_{inf}, Aₛᵤₚ, which surmounts the lower area, and in which a propagation mode of the electromagnetic wave is guided.

9. The method as claimed in claim 8, wherein the radiation dose is greater than or equal to the threshold above which the free carriers originating from the p-n junction or from the p-i-n structure no longer travel in the upper area of the core where the propagation mode of the electromagnetic wave is guided.

10. The method as claimed in claim 1, wherein step b) is executed in such a way that the resulting waveguide comprises an encapsulation layer enclosing the optical sheath.
